(19) United States
(12) Patent Application Publication
(10) Pub. No.: US 2026/0267022 A1
(43) Pub. Date: Sep. 10, 2026

(54) PROCESSING METHOD AND APPARATUS OF POST-EARTHQUAKE SURFACE PERMANENT DISPLACEMENT ESTIMATION MODEL AND PROCESSING DEVICE

(71) Applicant: JIANGHAN UNIVERSITY, Wuhan (CN)

(72) Inventors: Longjun XU, Wuhan (CN); Hao TIAN, Wuhan (CN); Jie WANG, Wuhan (CN); Chaoyue JIN, Wuhan (CN); Huabei LIU, Wuhan (CN); Heng ZHANG, Wuhan (CN); Qihan XU, Wuhan (CN)

(73) Assignee: JIANGHAN UNIVERSITY, Wuhan (CN)

(21) Appl. No.: 19/231,461

(22) Filed: Jun. 7, 2025

(30) Foreign Application Priority Data
Mar. 5, 2025 (CN) 2025102515890

(51) Int. Cl. G01V 1/30; G01V 1/01

(52) U.S. Cl. CPC G01V 1/30; G01V 1/01

(57) ABSTRACT

The present invention provides a processing method and apparatus of a post-earthquake surface permanent displacement estimation model and a processing device, which are used for providing a set of specific model processing solutions and making improvements in details, so as to obtain a post-earthquake surface permanent displacement estimation model with universality for various scenarios, convenient configuration of input data, and high processing efficiency, meet a demand for high-quality prediction of post-earthquake surface permanent displacement in an actual situation, and provide accurate and effective data support for engineering activities.

### CROSS-REFERENCE TO RELATED APPLICATIONS

The application claims priority to Chinese patent application No. 2025102515890, filed on Mar. 5, 2025, the entire contents of which are incorporated herein by reference.

### TECHNICAL FIELD

The present invention relates to the field of analysis on post-earthquake surface permanent displacement, and in particular, to a processing method and apparatus of a post-earthquake surface permanent displacement estimation model and a processing device.

### BACKGROUND

Earthquake is a ground movement caused by rapid release of energy in the earth's crust, and extrusion and collision between plates is a main cause of earthquake. A place where an earthquake started is called an earthquake focus, and the ground directly above the earthquake focus is called an earthquake epicenter. Earthquakes often cause serious casualties and economic losses, and may also cause secondary disasters such as mudslides, tsunamis, and landslides.

In an actual situation, many projects mainly adopt avoidance measures to reduce the influence of fault dislocation, but many projects inevitably cross over active faults, so it is very necessary for construction of these projects to reasonably estimate post-earthquake surface permanent displacement.

However, it is found by the inventors of the present invention that in the prior art, obtaining the post-earthquake surface permanent displacement is usually based on a baseline correction method. However, it needs a large number of stations to obtain enough measured ground motion records, and even if there are enough ground motion records, a proportion of records with permanent displacement is very low, which is difficult to adapt to various types of earthquake scenarios and sites. However, the ground motion simulation technology relies too much on the accuracy of a seismological model, which has a large error in practical applications and often cannot accurately simulate permanent displacement of a specific site.

### SUMMARY

The present invention provides a processing method and apparatus of a post-earthquake surface permanent displacement estimation model and a processing device, which are used for providing a set of specific model processing solutions and making improvements in details, so as to obtain a post-earthquake surface permanent displacement estimation model with universality for various scenarios, convenient configuration of input data, and high processing efficiency, meet a demand for high-quality prediction of post-earthquake surface permanent displacement in an actual situation, and provide accurate and effective data support for engineering activities.

According to a first aspect, the present invention provides a processing method of a post-earthquake surface permanent displacement estimation model, including:
obtaining ground motion acceleration time-history data in a target area;
obtaining corresponding peak ground displacement and permanent displacement based on the ground motion acceleration time-history data;
obtaining a moment magnitude, a focal depth, a fault type, a rupture distance, and a site shear wave velocity of the target area; and
establishing a post-earthquake surface permanent displacement estimation model based on the peak ground displacement, the permanent displacement, the moment magnitude, the focal depth, the fault type, the rupture distance, and the site shear wave velocity, where the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

With reference to the first aspect of the present invention, in a first possible implementation of the first aspect of the present invention, the obtaining corresponding peak ground displacement and permanent displacement based on the ground motion acceleration time-history data includes:
performing secondary integration on acceleration time-history obtained by baseline correction and filtering processing on the ground motion acceleration time-history data, and then taking a maximum absolute value of displacement time-history obtained by the secondary integration to obtain the peak ground displacement; and
processing the ground motion acceleration time-history data based on a baseline correction method for recovery of the observation value of permanent displacement to obtain the permanent displacement.

With reference to the first aspect of the present invention, in a second possible implementation of the first aspect of the present invention, a quantitative formula involved in the post-earthquake surface permanent displacement estimation model is specifically:

$$ln ( PD ) = {α}_{1} ln ( PGD ) + {F}_{source} + {F}_{path} + {F}_{site} + δ B + δ W ,$$

where PD is an estimated value of permanent displacement, α₁ is a first coefficient obtained by regression analysis on a random effect model, PGD is a peak ground displacement parameter, F_{source} is a source item, F_{Path} is a path item, Fₛᵢₜₑ is a site item, δB is an inter-event residual error, and δW is an intra-event residual error, where the source item is determined by a moment magnitude parameter, a fault type parameter, and a focal depth parameter, the path item is determined by the moment magnitude parameter, a reference magnitude parameter, and a rupture distance parameter, and the site item is determined by a site shear wave velocity parameter.

With reference to the second possible implementation of the first aspect of the present invention, in a third possible implementation of the first aspect of the present invention, the source item is specifically represented as:

$${F}_{Source} = {α}_{2} {M}_{w} + {e}_{i} {F}_{sofi} + {α}_{3} depth ,$$

where α₂ is a second coefficient obtained by regression analysis on the random effect model, M_{w} is the moment magnitude parameter, F_{sofi} is the fault type parameter, eᵢ is a coefficient obtained by regression analysis, i=1, 2, 3, corresponding to a strike-slip fault, a thrust fault, and normal fault respectively, α₃ is a third coefficient obtained by regression analysis on the random effect model, and depth is the focal depth parameter.

With reference to the second possible implementation of the first aspect of the present invention, in a fourth possible implementation of the first aspect of the present invention, the path item is specifically represented as:

$${F}_{Path} = ( {a}_{4} ( {M}_{w} - {M}_{ref} ) + {a}_{5} ) ln \sqrt{{R}_{rup}^{2} + {a}_{6}^{2}} ,$$

where α₄ is a fourth coefficient obtained by regression analysis on the random effect model, M_{w} is the moment magnitude parameter, M_{ref} is the reference magnitude parameter, α₅ is a fifth coefficient obtained by regression analysis on the random effect model, Rᵣᵤₚ is the rupture distance parameter, and α₆ is a preset coefficient introduced to explain a near-field saturation effect.

With reference to the second possible implementation of the first aspect of the present invention, in a fifth possible implementation of the first aspect of the present invention, the site item is specifically represented as:

$${F}_{site} = {α}_{7} ln ( {V}_{s 30} / 800 ) ,$$

where α₇ is a seventh coefficient obtained by regression analysis on the random effect model, and V_{S30} is an average shear wave velocity of 30 m below the surface.

With reference to the first aspect of the present invention, in a sixth possible implementation of the first aspect of the present invention, after establishing a post-earthquake surface permanent displacement estimation model based on the peak ground displacement, the permanent displacement, the moment magnitude, the focal depth, the fault type, the rupture distance, and the site shear wave velocity, the method further includes:
obtaining data to be processed in the target area, where the data to be processed includes target peak ground displacement, a moment magnitude, a target focal depth, a target fault type, a target rupture distance, and a target site shear wave velocity;
inputting the data to be processed into the post-earthquake surface permanent displacement estimation model, so that the post-earthquake surface permanent displacement estimation model performs corresponding post-earthquake surface permanent displacement estimation processing; and
extracting a post-earthquake surface permanent displacement estimation result output by the post-earthquake surface permanent displacement estimation model.

According to a second aspect, the present invention provides a processing apparatus of a post-earthquake surface permanent displacement estimation model, including:
a first obtaining unit, configured to obtain ground motion acceleration time-history data in a target area;
a second obtaining unit, configured to obtain corresponding peak ground displacement and permanent displacement based on the ground motion acceleration time-history data;
a third obtaining unit, configured to obtain a moment magnitude, a focal depth, a fault type, a rupture distance, and a site shear wave velocity of the target area; and
an establishment unit, configured to establish a post-earthquake surface permanent displacement estimation model based on the peak ground displacement, the permanent displacement, the moment magnitude, the focal depth, the fault type, the rupture distance, and the site shear wave velocity, where the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

With reference to the second aspect of the present invention, in a first possible implementation of the second aspect of the present invention, the second obtaining unit is specifically configured to:
perform secondary integration on acceleration time-history obtained by baseline correction and filtering processing on the ground motion acceleration time-history data, and then take a maximum absolute value of displacement time-history obtained by the secondary integration to obtain the peak ground displacement; and
process the ground motion acceleration time-history data based on a baseline correction method for recovery of the observation value of permanent displacement to obtain the permanent displacement.

With reference to the second aspect of the present invention, in a second possible implementation of the second aspect of the present invention, a quantitative formula involved in the post-earthquake surface permanent displacement estimation model is specifically:

$$ln ( PD ) = {α}_{1} ln ( PGD ) + {F}_{source} + {F}_{path} + {F}_{site} + δ B + δ W ,$$

where PD is an estimated value of permanent displacement, α₁ is a first coefficient obtained by regression analysis on a random effect model, PGD is a peak ground displacement parameter, F_{Source} is a source item, F_{Path} is a path item, F_{Site} is a site item, δB is an inter-event residual error, and δW is an intra-event residual error, where the source item is determined by a moment magnitude parameter, a fault type parameter, and a focal depth parameter, the path item is determined by the moment magnitude parameter, a reference magnitude parameter, and a rupture distance parameter, and the site item is determined by a site shear wave velocity parameter.

With reference to the second possible implementation of the second aspect of the present invention, in a third possible implementation of the second aspect of the present invention, the source item is specifically represented as:

$${F}_{S o u r c e} = {α}_{2} {M}_{w} + {e}_{i} {F}_{s o f i} + {α}_{3} depth$$

where α₂ is a second coefficient obtained by regression analysis on the random effect model, M_{w} is the moment magnitude parameter, F_{sofi} is the fault type parameter, eᵢ is a coefficient obtained by regression analysis, i=1, 2, 3, corresponding to a strike-slip fault, a thrust fault, and normal fault respectively, α₃ is a third coefficient obtained by regression analysis on the random effect model, and depth is the focal depth parameter.

With reference to the second possible implementation of the second aspect of the present invention, in a fourth possible implementation of the second aspect of the present invention, the path item is specifically represented as:

$${F}_{Path} = ( {a}_{4} ( {M}_{w} - {M}_{r e f} ) + {a}_{5} ) ln \sqrt{{R}_{rup}^{2} + {a}_{6}^{2}} ,$$

where α₄ is a fourth coefficient obtained by regression analysis on the random effect model, M_{w} is the moment magnitude parameter, M_{ref} is the reference magnitude parameter, α₅ is a fifth coefficient obtained by regression analysis on the random effect model, Rᵣᵤₚ is the rupture distance parameter, and α₆ is a preset coefficient introduced to explain a near-field saturation effect.

With reference to the second possible implementation of the second aspect of the present invention, in a fifth possible implementation of the second aspect of the present invention, the site item is specifically represented as:

$${F}_{site} = {α}_{7} ln ( {V}_{s 30} / 800 ) ,$$

where α₇ is a seventh coefficient obtained by regression analysis on the random effect model, and V_{S30} is an average shear wave velocity of 30 m below the surface.

With reference to the second aspect of the present invention, in a sixth possible implementation of the second aspect of the present invention, the apparatus further includes an application unit, configured to:
obtain data to be processed in the target area, where the data to be processed includes target peak ground displacement, a moment magnitude, a target focal depth, a target fault type, a target rupture distance, and a target site shear wave velocity;
input the data to be processed into the post-earthquake surface permanent displacement estimation model, so that the post-earthquake surface permanent displacement estimation model performs corresponding post-earthquake surface permanent displacement estimation processing; and
extract a post-earthquake surface permanent displacement estimation result output by the post-earthquake surface permanent displacement estimation model.

According to a third aspect, the present invention provides a processing device, including a processor and a memory, where the memory stores a computer program, and the processor executes the method according to the first aspect or any one of possible implementations of the first aspect when calling the computer program in the memory.

According to a fourth aspect, the present invention provides a computer-readable storage medium; the computer-readable storage medium stores a plurality of instructions; and the instructions are suitable for being loaded by a processor and executing the method provided by the first aspect of the present invention or any possible implementation of the first aspect of the present invention.

It can be seen from the above content that the present application has the following beneficial effects:

For an objective of estimating post-earthquake surface permanent displacement, the present invention provides a set of specific model processing solutions, so as to obtain a post-earthquake surface permanent displacement estimation model with universality for various scenarios, convenient configuration of input data, and high processing efficiency, meet a demand for high-quality prediction of post-earthquake surface permanent displacement in an actual situation, and provide accurate and effective data support for engineering activities.

### BRIEF DESCRIPTION OF THE DRAWINGS

To describe the technical solutions in the embodiments of the present application more clearly, the accompanying drawings required to describe the merely embodiments are briefly described below. Apparently, the accompanying drawings described below are only some embodiments of the present application. Those skilled in the art may further obtain other accompanying drawings based on these accompanying drawings without creative efforts.

FIG. 1 is a schematic flowchart of a processing method of a post-earthquake surface permanent displacement estimation model according to the present invention;

FIG. 2 is a schematic structural diagram of a processing apparatus of a post-earthquake surface permanent displacement estimation model according to the present invention; and

FIG. 3 is a structural schematic diagram of a processing device according to the present invention.

### DETAILED DESCRIPTION OF THE EMBODIMENTS

The technical solutions in the embodiments of the present application will be clearly and completely described below with reference to the accompanying drawings in the embodiments of the present application. Apparently, the described embodiments are merely some rather than all of the embodiments of the present application. All other embodiments obtained by those skilled in the art based on the embodiments of the present application without creative efforts shall fall within the protection scope of the present application.

The terms “first”, “second”, and so on in the description and claims of the present application and in the above accompanying drawings are intended to distinguish between similar objects but do not necessarily indicate a specific order or sequence. It should be understood that data used in such a way may be exchanged under proper conditions to make it possible to implement the embodiments described here in other sequences apart from those illustrated or described here. Moreover, the terms “include”, “comprise”, and any other variants mean to cover the non-exclusive inclusion, for example, a process, method, system, product, or device that includes a list of steps or modules is not necessarily limited to those steps or modules which are clearly listed, but may include other steps or units which are not expressly listed or inherent to such a process, method, system, product, or device. The names or numbers of steps in the present application do not mean that the steps in the method flow must be executed in a time/logical sequence indicated by the names or numbers, and the execution order of the named or numbered process steps can be changed according to the technical purpose to be achieved, as long as the same or similar technical effects can be achieved.

The division of modules appearing in the present application is based on logic, and there may be other division methods when the division is realized in actual application. For example, a plurality of modules can be incorporated or integrated into another system, or some features can be ignored or are not executed; furthermore, the mutual coupling or direct coupling or communication connection shown or discussed can be realized through certain interfaces, and the indirect coupling or communication connection between the modules can be electrical or other similar forms, which are not limited in the present application. Also, the modules or submodules mentioned above as separate components can be, or may not be physically separated, or may not be physical modules, or can be distributed across a plurality of circuit modules; and some or all of the modules can be selected according to actual needs to achieve the purpose of the solution of the present application.

Before introducing a processing method of a post-earthquake surface permanent displacement estimation model provided by the present invention, background content involved in the present invention is first introduced.

The processing method and apparatus of a post-earthquake surface permanent displacement estimation model and a computer-readable storage medium provided by the present invention may be applied in a processing device, which are used for providing a set of specific model processing solutions and making improvements in details, so as to obtain a post-earthquake surface permanent displacement estimation model with universality for various scenarios, convenient configuration of input data, and high processing efficiency, meet a demand for high-quality prediction of post-earthquake surface permanent displacement in an actual situation, and provide accurate and effective data support for engineering activities.

The processing method of the post-earthquake surface permanent displacement estimation model mentioned in the present invention may be executed by the processing apparatus of the post-earthquake surface permanent displacement estimation model, or different types of processing devices such as a server, a physical host, or a user equipment (UE) integrated with the processing apparatus of the post-earthquake surface permanent displacement estimation model. The processing apparatus of the post-earthquake surface permanent displacement estimation model may be implemented in hardware or software, the UE may be a terminal device such as a smart phone, a tablet computer, a notebook computer, a desktop computer, or a personal digital assistant (Personal Digital Assistant, PDA), and the processing device may be set in a device cluster mode.

It may be understood that in practical applications, considering that the solution of the present invention is usually a training process based on existing data, therefore, the processing device that implements the processing method of the post-earthquake surface permanent displacement estimation model of the present invention only needs to have corresponding data processing capabilities, and its specific types of device and forms of device deployment are relatively flexible.

However, if subsequent model application is also involved, it may be adjusted according to specific application scenarios. For example, the processing device may be a related device in an engineering site, or it may also be a related device that provides remote data support services for an engineering site in a form of a web service.

As an example, the processing device may include a first processing device for performing model training in the background and a second processing device for performing model application in the engineering site. The first processing device may send a model obtained by continuous updating after first training or practical application to the second processing device for performing model deployment, so as to carry out specific model application in the site and provide data support for post-earthquake surface permanent displacement in the engineering site.

The processing method of the post-earthquake surface permanent displacement estimation model provided by the present invention is described in the following.

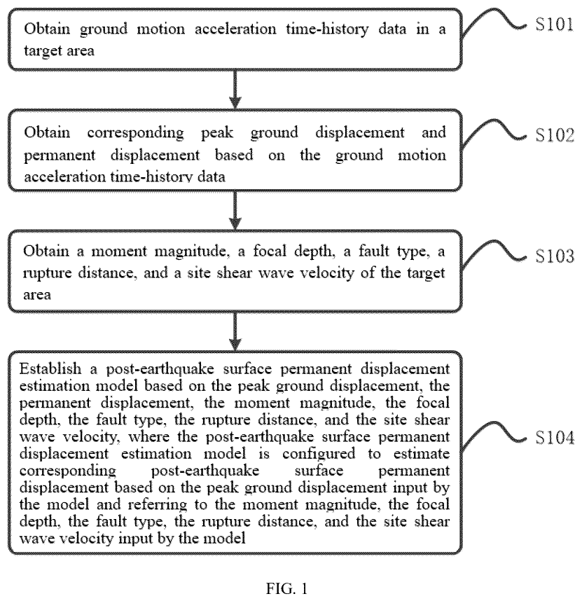

First of all, referring to FIG. 1, FIG. 1 shows a schematic flowchart of a processing method of a post-earthquake surface permanent displacement estimation model according to the present invention. The processing method of the post-earthquake surface permanent displacement estimation model provided by the present invention may specifically include the following steps S101 to S104.

Step S101: Obtain ground motion acceleration time-history data in a target area.

It may be understood that the post-earthquake surface permanent displacement estimation model to be constructed in the present invention is linked to a specific area. The specific area is designated as the target area (a geographical area and an actual area) in the present invention, so that the post-earthquake surface permanent displacement estimation model may be highly targeted to the target area, and a high-precision post-earthquake surface permanent displacement estimation effect may be achieved.

In the case that the target area is determined, the present invention may obtain corresponding ground motion acceleration time-history data (also referred to as a ground motion acceleration time-history record, ground motion data, a ground motion record, etc.) from a local storage space, another device or by using a manual input manner. These data are original data obtained in the process of recording an earthquake, which may be obtained by a corresponding mathematical model, and are ready-made data in this field. Considering that how it is processed and obtained is not the focus of the present invention, details are not described again in the present invention.

As an example, the ground motion acceleration time-history data in the target area may be conveniently extracted from an existing related earthquake database.

It may also be seen from herein that the ground motion acceleration time-history data obtained in the present invention may be directly used as an existing data product, which is more convenient in the application of the solution.

In a specific operation, in order to facilitate data management and data processing, a ground motion acceleration time-history database may also be constructed for the target area, and the obtained ground motion acceleration time-history data may be recorded in a database form.

When original ground motion acceleration time-history data is obtained, appropriate data processing or data screening may also be performed to obtain more simplified data that meets the requirements of the solution of the present invention.

Specifically, data screening may be performed based on a data screening strategy/rule related to data quality, earthquake magnitude, and peak acceleration.

Step S102: Obtain corresponding peak ground displacement and permanent displacement based on the ground motion acceleration time-history data.

On the basis of the obtained ground motion acceleration time-history data, the data may be processed to obtain the peak ground displacement and the permanent displacement involved in the solution of the present invention, the former corresponds to the input of the model and the latter corresponds to the output of the model.

It may be understood that the peak ground displacement and the permanent displacement are two common terms in seismic analysis, and they have mature and common concepts and processing methods. Therefore, two data attributes of the corresponding peak ground displacement and permanent displacement may be extracted from data content of the ground motion acceleration time history data by existing technical means.

Certainly, it may also be understood that in an actual operation, further optimization and improvement may be made on the basis of the existing technical means, or novel self-developed technical means is adopted to obtain these two pieces of data.

As an exemplary embodiment, the obtaining corresponding peak ground displacement and permanent displacement based on the ground motion acceleration time-history data may specifically include:
performing secondary integration on acceleration time-history obtained by baseline correction and filtering processing on the ground motion acceleration time-history data, and then taking a maximum absolute value of displacement time-history obtained by the secondary integration to obtain the peak ground displacement; and
processing the ground motion acceleration time-history data based on a baseline correction method for recovery of the observation value of permanent displacement, which avoids filtering processing, to obtain the permanent displacement.

It may be understood that the obtaining method of the peak ground displacement and the permanent displacement in this embodiment is a mature existing solution, and its purpose is to provide a more specific and convenient landing supporting solution for practical applications.

In addition, after the peak ground displacement and the permanent displacement are obtained, secondary screening may also be performed on the previous ground motion acceleration time-history data to further simplify the data.

As an example, the ground motion acceleration time-history data without post-earthquake permanent displacement or with post-earthquake permanent displacement less than a given threshold (such as 5 cm) may be deleted.

Step S103: Obtain a moment magnitude, a focal depth, a fault type, a rupture distance, and a site shear wave velocity of the target area.

It may be understood that in the model design of the present invention, the model input involves not only the peak ground displacement but also other auxiliary parameters, or in other words, the present invention takes the peak ground displacement as a secondary parameter and considers other auxiliary parameters in the process of estimating the post-earthquake surface permanent displacement.

The auxiliary parameters may specifically involve the moment magnitude, the focal depth, the fault type, the rupture distance, and the site shear wave velocity (a shear wave velocity at 30 m below horizontal site/30 m below the surface).

In this case, the corresponding moment magnitude, focal depth, fault type, rupture distance and site shear wave velocity may be extracted from the previous ground motion acceleration time-history data or from the data in other places of the target area.

It should be noted that some data may not necessarily be included in the previous ground motion acceleration time-history data. Here, the obtaining of these parameters is relatively flexible. In addition to extracting ready-made data or performing simple data analysis and secondary processing to obtain, manual input is also an option.

For example, the rupture distance may be calculated based on a stochastic finite fault model, and the site shear wave velocity may also be calculated based on site geological data of a station.

In addition, it may also be seen that the data processing in step S103 usually has no specific limiting relationship with previous steps S101 and S102.

Step S104: Establish a post-earthquake surface permanent displacement estimation model based on the peak ground displacement, the permanent displacement, the moment magnitude, the focal depth, the fault type, the rupture distance, and the site shear wave velocity, where the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

However, after completing the obtaining of the peak ground displacement, permanent displacement, moment magnitude, focal depth, fault type, rupture distance and site shear wave velocity (these data may be used as training samples for training the model), specific model training work may be carried out to train the post-earthquake surface permanent displacement estimation model specially used for post-earthquake surface permanent displacement estimation processing.

It may be understood that for the post-earthquake ground permanent displacement estimation model configured in the present invention, the involved model type and the model training framework or loss function used in the training process may adopt an existing solution, or optimization and improvement are made on the basis of the existing solution, and may also adopt a novel self-developed solution, which are all possible in practical situations.

A key point of the post-earthquake surface permanent displacement estimation model is to configure a post-earthquake surface permanent displacement estimation logic involved in the present invention, which estimates corresponding post-earthquake surface permanent displacement based on the peak ground displacement input by the model and referring to the moment magnitude, the focal depth, the fault type, the rupture distance, and the site shear wave velocity input by the model.

As an exemplary embodiment, a quantitative formula involved in the post-earthquake surface permanent displacement estimation model designed by the present invention is specifically:

$$ln ( PD ) = {α}_{I} ln ( PGD ) + {F}_{s o u r c e} + {F}_{path} + {F}_{site} + δ B + δ W ,$$

where PD is an estimated value of permanent displacement (unit: cm), α₁ is a first coefficient obtained by regression analysis on a random effect model, PGD is a peak ground displacement parameter (unit: cm), F_{Source} is a source item, F_{Path} is a path item, Fₛᵢₜₑ is a site item, δB is an inter-event residual error, and δW is an intra-event residual error, where the source item is determined by a moment magnitude parameter, a fault type parameter, and a focal depth parameter, the path item is determined by the moment magnitude parameter, a reference magnitude parameter, and a rupture distance parameter, and the site item is determined by a site shear wave velocity parameter.

It may be seen that in this embodiment, starting from a formula level, the present invention specially designs a set of more specific quantitative formula for the estimation logic involved in the post-earthquake surface permanent displacement estimation model compared with an original “black box” state. Therefore, the application of the solution may be more convenient in practical applications, and a more stable and accurate estimation effect is also helpful to be realized, which has a better practical value.

It should be noted that the two parameters, PGD and PD, which are the input and output of the post-earthquake surface permanent displacement estimation model, may be a geometric average in a horizontal direction, a RotD50, a value in a vertical fault direction and a parallel fault direction, or a vertical component.

Further, as an exemplary embodiment, the source item in the above post-earthquake surface permanent displacement estimation formula may be represented as:

$${F}_{S o u r c e} = {α}_{2} {M}_{w} + {e}_{i} {F}_{s o f i} + {α}_{3} depth ,$$

where α₂ is a second coefficient obtained by regression analysis on the random effect model, M_{w} is the moment magnitude parameter, F_{sofi} is the fault type parameter (a dummy variable), eᵢ is a coefficient obtained by regression analysis, i=1, 2, 3, corresponding to a strike-slip fault (SS), a thrust fault (TF), and normal fault (NF) respectively, α₃ is a third coefficient obtained by regression analysis on the random effect model, and depth is the focal depth parameter.

Further, as an exemplary embodiment, the path item in the above post-earthquake surface permanent displacement estimation formula may be represented as:

$${F}_{Path} = ( {a}_{4} ( {M}_{w} - {M}_{r e f} ) + {a}_{5} ) ln \sqrt{{R}_{r u p}^{2} + {a}_{6}^{2}} ,$$

where α₄ is a fourth coefficient obtained by regression analysis on the random effect model, M_{w} is the moment magnitude parameter, M_{ref} is the reference magnitude parameter (determined by magnitude distribution), α₅ is a fifth coefficient obtained by regression analysis on the random effect model, Rᵣᵤₚ is the rupture distance parameter (unit: km), and α₆ is a coefficient (determined through a trial-and-error method) introduced to explain a near-field saturation effect.

Further, as an exemplary embodiment, the site item in the above post-earthquake surface permanent displacement estimation formula may be represented as:

$${F}_{site} = {α}_{7} ln ( {V}_{s 30} / 800 ) ,$$

where α₇ is a seventh coefficient obtained by regression analysis on the random effect model, and V_{S30} is an average shear wave velocity of 30 m below the surface (unit: m/s).

It may be understood that the above three exemplary embodiments are the three items involved in the post-earthquake surface permanent displacement estimation formula. It is of course of better practical significance to continue to provide a more specific supporting solution from the formula level, which is helpful to complete the solution deployment more conveniently and obtain a more accurate permanent displacement estimation result.

Besides, it should be noted that α₁, α₂, α₃, α₄, α₅, and α₇ are the coefficients determined in the process of model training, α₆ is the coefficient introduced to explain the near-field saturation effect, for example, it is determined as 5.0 by the trial-and-error method, and Mref is determined according to the magnitude distribution, for example, it is 6.7.

Certainly, these parameters may also be preset parameters or manually entered parameters, all of which are possible in practical applications and may be adjusted according to actual situations.

After the model training is completed, or in the training process, it may also involve model verification, and specifically, the rationality of the model may be verified through residual error analysis. If distribution of the residual error and a corresponding explanatory variable is close to unbiased distribution, it may be considered that the established ground motion model is reasonable and the model may be put into practical use in this case.

After the model construction and configuration work is completed, obviously, it may be put into the practical use process, and correspondingly, the method of the present invention can also involve a corresponding model application link.

Specifically, as an exemplary embodiment, after establishing a post-earthquake surface permanent displacement estimation model based on the peak ground displacement, the permanent displacement, the moment magnitude, the focal depth, the fault type, the rupture distance, and the site shear wave velocity in step S104, the method of the present invention may further include:
obtaining data to be processed in the target area, where the data to be processed includes target peak ground displacement, a moment magnitude, a target focal depth, a target fault type, a target rupture distance, and a target site shear wave velocity;
inputting the data to be processed into the post-earthquake surface permanent displacement estimation model, so that the post-earthquake surface permanent displacement estimation model performs corresponding post-earthquake surface permanent displacement estimation processing; and
extracting a post-earthquake surface permanent displacement estimation result output by the post-earthquake surface permanent displacement estimation model.

It is easily understood that in the practical application of the model, the model input, that is, the data to be processed, corresponds to the training sample in the model training process in terms of data formats and data content, and specifically, may also involve ready-made related data products or data obtained by processing on the basis of the ready-made data products.

The obtaining manner of the data to be processed is related to a specific deployment solution of the model in the practical situations, which may be entered manually or automatically obtained by a system according to a corresponding obtaining strategy/rule. For example, the data recorded in the target area may be continuously monitored on the system, so as to independently initiate the corresponding post-earthquake surface permanent displacement estimation processing in the case of data updating. For another example, the corresponding data records may be automatically extracted from the system under the corresponding triggering conditions other than data updating, and then the corresponding post-earthquake surface permanent displacement estimation processing may be independently initiated. Obviously, the specific independent obtaining manner is relatively flexible and may be adjusted according to actual business needs.

However, after the current data to be processed is imported into the post-earthquake surface permanent displacement estimation model, it is obvious that the model can carry out corresponding processing and output a corresponding post-earthquake surface permanent displacement estimation result after completing the processing. In this case, the post-earthquake surface permanent displacement estimation result may be extracted.

It may be understood that in the case of extracting the post-earthquake surface permanent displacement estimation result, data application processing such as local storage, off-site storage, content display, prompt for output completion or further data analysis may be carried out according to a preset data application strategy or a real-time configured data application strategy, which is also relatively flexible.

Furthermore, it is also worth adding that the application scenarios applicable to the practical application of the solution in the present invention may not only be oriented to engineering projects involving active faults, but also to early warning of geological disasters. As long as there is a demand for understanding and using the data of post-earthquake surface permanent displacement, obviously, it may be met through the application of the solution in the present invention.

Finally, for the above contents of the solution (including the contents of the solution in various exemplary embodiments), in general, for an objective of estimating post-earthquake surface permanent displacement, the present invention provides a set of specific model processing solutions and makes improvements in details, so as to obtain a post-earthquake surface permanent displacement estimation model with universality for various scenarios, convenient configuration of input data, and high processing efficiency, meet a demand for high-quality prediction of post-earthquake surface permanent displacement in an actual situation, and provide accurate and effective data support for engineering activities.

The above is an introduction to the processing method of the post-earthquake surface permanent displacement estimation model provided by the present invention. In order to better implement the processing method of the post-earthquake surface permanent displacement estimation model provided by the present invention, the present invention also provides a processing apparatus of the post-earthquake surface permanent displacement estimation model from the perspective of functional modules.

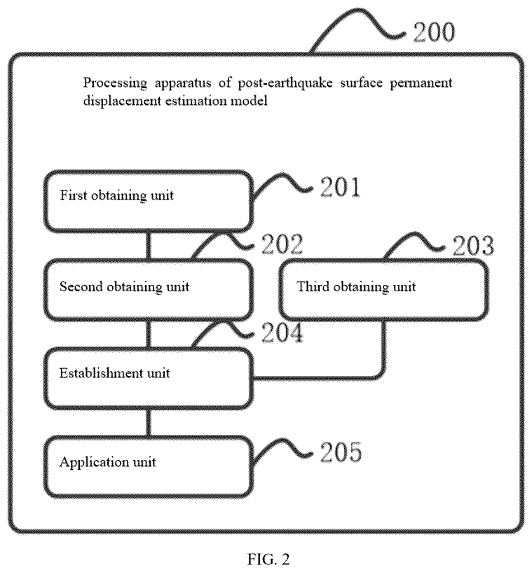

Referring to FIG. 2, FIG. 2 is a schematic structural diagram of a processing apparatus of a post-earthquake surface permanent displacement estimation model according to the present invention. In the present invention, the processing apparatus 200 of the post-earthquake surface permanent displacement estimation model may specifically include the following structures:
a first obtaining unit 201, configured to obtain ground motion acceleration time-history data in a target area;
a second obtaining unit 202, configured to obtain corresponding peak ground displacement and permanent displacement based on the ground motion acceleration time-history data;
a third obtaining unit 203, configured to obtain a moment magnitude, a focal depth, a fault type, a rupture distance, and a site shear wave velocity of the target area; and
an establishment unit 204, configured to establish a post-earthquake surface permanent displacement estimation model based on the peak ground displacement, the permanent displacement, the moment magnitude, the focal depth, the fault type, the rupture distance, and the site shear wave velocity, where the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

As an exemplary embodiment, the second obtaining unit 202 is specifically configured to:
perform secondary integration on acceleration time-history obtained by baseline correction and filtering processing on the ground motion acceleration time-history data, and then take a maximum absolute value of displacement time-history obtained by the secondary integration to obtain the peak ground displacement; and
process the ground motion acceleration time-history data based on a baseline correction method for permanent displacement recovery to obtain the permanent displacement.

As another exemplary embodiment, a quantitative formula involved in the post-earthquake surface permanent displacement estimation model is specifically:

$$ln ( PD ) = {α}_{1} ln ( PGD ) + {F}_{s o u r c e} + {F}_{path} + {F}_{site} + δ B + δ W ,$$

where PD is an estimated value of permanent displacement, α₁ is a first coefficient obtained by regression analysis on a random effect model, PGD is a peak ground displacement parameter, F_{source} is a source item, F_{Path} is a path item, Fₛᵢₜₑ is a site item, δB is an inter-event residual error, and δW is an intra-event residual error, where the source item is determined by a moment magnitude parameter, a fault type parameter, and a focal depth parameter, the path item is determined by the moment magnitude parameter, a reference magnitude parameter, and a rupture distance parameter, and the site item is determined by a site shear wave velocity parameter.

As another exemplary embodiment, the source item is specifically represented as:

$${F}_{S o u r c e} = {α}_{2} {M}_{w} + {e}_{i} {F}_{s o f i} + {α}_{3} depth$$

where α₂ is a second coefficient obtained by regression analysis on the random effect model, M_{w} is the moment magnitude parameter, F_{sofi} is the fault type parameter, eᵢ is a coefficient obtained by regression analysis, i=1, 2, 3, corresponding to a strike-slip fault, a thrust fault, and normal fault respectively, α₃ is a third coefficient obtained by regression analysis on the random effect model, and depth is the focal depth parameter.

As another exemplary embodiment, the path item is specifically represented as:

$${F}_{Path} = ( {a}_{4} ( {M}_{w} - {M}_{r e f} ) + {a}_{5} ) ln \sqrt{{R}_{r u p}^{2} + {a}_{6}^{2}} ,$$

where α₄ is a fourth coefficient obtained by regression analysis on the random effect model, M_{w} is the moment magnitude parameter, M_{ref} is the reference magnitude parameter, α₅ is a fifth coefficient obtained by regression analysis on the random effect model, Rᵣᵤₚ is the rupture distance parameter, and α₆ is a preset coefficient introduced to explain a near-field saturation effect.

As another exemplary embodiment, the site item is specifically represented as:

$${F}_{site} = {α}_{7} ln ( {V}_{s 30} / 800 ) ,$$

where α₇ is a seventh coefficient obtained by regression analysis on the random effect model, and V_{S30} is an average shear wave velocity of 30 m below the surface.

As an exemplary embodiment, the apparatus further includes an application unit 205, configured to:
obtain data to be processed in the target area, where the data to be processed includes target peak ground displacement, a moment magnitude, a target focal depth, a target fault type, a target rupture distance, and a target site shear wave velocity;
input the data to be processed into the post-earthquake surface permanent displacement estimation model, so that the post-earthquake surface permanent displacement estimation model performs corresponding post-earthquake surface permanent displacement estimation processing; and
extract a post-earthquake surface permanent displacement estimation result output by the post-earthquake surface permanent displacement estimation model.

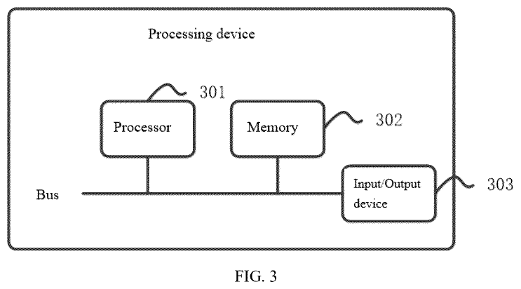

The present invention also provides a processing device from the perspective of a hardware structure. Referring to FIG. 3, FIG. 3 shows a structural schematic diagram of a processing device according to the present invention. Specifically, the processing device of the present application may include a processor 301, a memory 302, and an input/output device 303. The processor 301 is configured to implement the steps of the processing method of the post-earthquake ground surface permanent displacement estimation model in the corresponding embodiment of FIG. 1 when executing the computer program stored in the memory 302; alternatively, the processor 301 is configured to implement functions of each unit in the corresponding embodiment of FIG. 2 when executing the computer program stored in the memory 302. The memory 302 is configured to store the computer program required by the processor 301 to execute the processing method of the post-earthquake ground surface permanent displacement estimation model in the corresponding embodiment of FIG. 1.

Exemplarily, the computer program can be divided into one or more modules/units, which are stored in the memory 302 and executed by the processor 301 to complete the present invention. The one or more modules/units may be a series of computer program instruction segments capable of completing specific functions, and the instruction segments are used for describing an execution process of the computer program in a computer apparatus.

The processing device may include, but is not limited to the processor 301, the memory 302, and the input/output device 303. A person skilled in the art may understand that the schematic diagram is only an example of the processing device, and does not constitute a limitation on the processing device. The device may include more or fewer components than those shown in the diagram, or combine certain components, or different components. For example, the processing device may also include a network access device, a bus, and the like, and the processor 301, the memory 302, and the input/output device 303 are connected via the bus.

The processor 301 may be a central processing unit (CPU), and may also be other general-purpose processors, a digital signal processor (DSP), an application specific integrated circuit (ASIC), a field-programmable gate array (FPGA) or other programmable logic devices, a discrete gate or a transistor logic device, a discrete hardware component, and the like. The general-purpose processor may be a microprocessor, any conventional processor, or the like. The processor is a control center of the processing device. Various parts of the entire processing device are connected through various interfaces and lines.

The memory 302 may be configured to store the computer programs and/or modules, and the processor 301 operates or executes the computer programs and/or modules stored in the memory 302, as well as calls data stored in the memory 302, to achieve various functions of the computer apparatus. The memory 302 may mainly include a program storage area and a data storage area, where the program storage area may store an operating system, at least one application program required for functions; and the data storage area may store data created according to the use of the processing device. In addition, the memory may include a high-speed random access memory, as well as a non-volatile memory such as a hard drive, a memory, a plug-in hard disk, a smart media card (SMC), a secure digital (SD) card, a flash card, at least one disk storage device, a flash device, or other volatile solid-state storage devices.

The processor 301 may specifically implement the following functions when configured to execute the computer program stored on the memory 302:
obtaining ground motion acceleration time-history data in a target area;
obtaining corresponding peak ground displacement and permanent displacement based on the ground motion acceleration time-history data;
obtaining a moment magnitude, a focal depth, a fault type, a rupture distance, and a site shear wave velocity of the target area; and
establishing a post-earthquake surface permanent displacement estimation model based on the peak ground displacement, the permanent displacement, the moment magnitude, the focal depth, the fault type, the rupture distance, and the site shear wave velocity, where the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

It may be clearly understood by those skilled in the art that, for convenience and brevity of description, for the specific operation processes of the processing apparatus of the post-earthquake surface permanent displacement estimation model, the processing device as well as its corresponding unit described above, reference may be made to the description of the processing method of the post-earthquake surface permanent displacement estimation model in corresponding embodiment of FIG. 1, and details are not described herein again.

Those skilled in the art can understand that all or part of steps in various methods of the above embodiments can be completed by instructions or by controlling related hardware through the instructions, which can be stored in a computer-readable storage medium and loaded and executed by a processor.

To this end, the present application provides a computer-readable storage medium, where a plurality of instructions are stored, which can be loaded by a processor to execute the steps of the processing method of the post-earthquake surface permanent displacement estimation model in the corresponding embodiment of FIG. 1 of the present invention. For specific operations, reference may be made to the description of the processing method of the post-earthquake surface permanent displacement estimation model in the corresponding embodiment of FIG. 1. Details are not described herein again.

Where, the computer-readable storage medium may include: a read only memory (ROM), a random access memory (RAM), a magnetic disk or an optical disk and the like.

Due to the instructions stored in this computer-readable storage medium, the steps of the processing method of the post-earthquake surface permanent displacement estimation model in the corresponding embodiment of FIG. 1 of the present invention may be executed. Therefore, the beneficial effects that may be achieved by the processing method of the post-earthquake surface permanent displacement estimation model in the corresponding embodiment of FIG. 1 of the present invention may be achieved. See the previous description for details, and details are not described herein again.

The processing method and apparatus of a post-earthquake surface permanent displacement estimation model, the processing device, and the computer-readable storage medium are introduced in detail above. The principle and implementations of the present invention are elaborated by applying specific examples herein. The descriptions of the above embodiments are only used to help understand the method and its core idea of the present invention. Meanwhile, according to the idea of the present invention, there will be changes in the specific implementations and the application scope for a person skilled in the art. In summary, the content of the specification should not be understood as a limitation to the present invention.

What is claimed is:

1. A processing method of a post-earthquake surface permanent displacement estimation model, comprising:
obtaining ground motion acceleration time-history data in a target area;
obtaining corresponding peak ground displacement and permanent displacement based on the ground motion acceleration time-history data;
obtaining a moment magnitude, a focal depth, a fault type, a rupture distance, and a site shear wave velocity of the target area; and
establishing a post-earthquake surface permanent displacement estimation model based on the peak ground displacement, the permanent displacement, the moment magnitude, the focal depth, the fault type, the rupture distance, and the site shear wave velocity, wherein the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

2. The method according to claim 1, wherein the obtaining corresponding peak ground displacement and permanent displacement based on the ground motion acceleration time-history data comprises:
performing secondary integration on acceleration time-history obtained by baseline correction and filtering processing on the ground motion acceleration time-history data, and then taking a maximum absolute value of displacement time-history obtained by the secondary integration to obtain the peak ground displacement; and
processing the ground motion acceleration time-history data based on a baseline correction method for recovery of the observation value of permanent displacement to obtain the permanent displacement.

3. The method according to claim 1, wherein a quantitative formula involved in the post-earthquake surface permanent displacement estimation model is specifically:
$$ln ( PD ) = {α}_{1} ln ( PGD ) + {F}_{s o u r c e} + {F}_{path} + {F}_{site} + δ B + δ W ,$$
wherein PD is an estimated value of permanent displacement, α₁ is a first coefficient obtained by regression analysis on a random effect model, PGD is a peak ground displacement parameter, F_{Source} is a source item, F_{Path} is a path item, F_{Site} is a site item, δB is an inter-event residual error, and δW is an intra-event residual error, wherein the source item is determined by a moment magnitude parameter, a fault type parameter, and a focal depth parameter, the path item is determined by the moment magnitude parameter, a reference magnitude parameter, and a rupture distance parameter, and the site item is determined by a site shear wave velocity parameter.

4. The method according to claim 3, wherein the source item is specifically represented as:
$${F}_{S o u r c e} = {α}_{2} {M}_{w} + {e}_{i} {F}_{s o f i} + {α}_{3} depth ,$$
wherein α₂ is a second coefficient obtained by regression analysis on the random effect model, M_{w} is the moment magnitude parameter, F_{sofi} is the fault type parameter, eᵢ is a coefficient obtained by regression analysis, i=1, 2, 3, corresponding to a strike-slip fault, a thrust fault, and normal fault respectively, α₃ is a third coefficient obtained by regression analysis on the random effect model, and depth is the focal depth parameter.

5. The method according to claim 3, wherein the path item is specifically represented as:
$${F}_{Path} = ( {a}_{4} ( {M}_{w} - {M}_{r e f} ) + {a}_{5} ) ln \sqrt{{R}_{r u p}^{2} + {a}_{6}^{2}} ,$$
wherein α₄ is a fourth coefficient obtained by regression analysis on the random effect model, M_{w} is the moment magnitude parameter, M_{ref} is the reference magnitude parameter, α₅ is a fifth coefficient obtained by regression analysis on the random effect model, Rᵣᵤₚ is the rupture distance parameter, and α₆ is a preset coefficient introduced to explain a near-field saturation effect.

6. The method according to claim 3, wherein the site item is specifically represented as:
$${F}_{site} = {α}_{7} ln ( {V}_{s 30} / 800 ) ,$$
wherein α₇ is a seventh coefficient obtained by regression analysis on the random effect model, and V_{S30} is an average shear wave velocity of 30 m below the surface.

7. The method according to claim 1, wherein after establishing a post-earthquake surface permanent displacement estimation model based on the peak ground displacement, the permanent displacement, the moment magnitude, the focal depth, the fault type, the rupture distance, and the site shear wave velocity, the method further comprises:
obtaining data to be processed in the target area, wherein the data to be processed comprises target peak ground displacement, a moment magnitude, a target focal depth, a target fault type, a target rupture distance, and a target site shear velocity;
inputting the data to be processed into the post-earthquake surface permanent displacement estimation model, so that the post-earthquake surface permanent displacement estimation model performs corresponding post-earthquake surface permanent displacement estimation processing; and
extracting a post-earthquake surface permanent displacement estimation result output by the post-earthquake surface permanent displacement estimation model.

8. A processing apparatus of a post-earthquake surface permanent displacement estimation model, comprising:
a first obtaining unit, configured to obtain ground motion acceleration time-history data in a target area;
a second obtaining unit, configured to obtain corresponding peak ground displacement and permanent displacement based on the ground motion acceleration time-history data;
a third obtaining unit, configured to obtain a moment magnitude, a focal depth, a fault type, a rupture distance, and a site shear wave velocity of the target area; and
an establishment unit, configured to establish a post-earthquake surface permanent displacement estimation model based on the peak ground displacement, the permanent displacement, the moment magnitude, the focal depth, the fault type, the rupture distance, and the site shear wave velocity, wherein the post-earthquake surface permanent displacement estimation model is configured to estimate corresponding post-earthquake surface permanent displacement based on the peak ground displacement input by the model and referring to the moment magnitude, the focal depth, the fault type, the rupture distance, and the site shear wave velocity input by the model.

9. A processing device, comprising a processor and a memory, wherein the memory stores a computer program, and the processor executes the method according to claim 1 when calling the computer program in the memory.

10. A computer-readable storage medium, wherein the computer-readable storage medium stores a plurality of instructions; and the instructions are suitable for being loaded by a processor to execute the method according to claim 1.
